(19) United States
(12) Patent Application Publication
(10) Pub. No.: US 2026/0217296 A1
(43) Pub. Date: Jul. 30, 2026

(54) CART FOR A MOBILE ROBOT, AND A BRAKE DEVICE FOR SUCH CART

(71) Applicant: ROEQ ApS, Vissenbjerg (DK)

(72) Inventors: Michael EJSTRUP HANSEN, Morud (DK); Carsten Sørensen, Herlev (DK); Christian Deichgraeber, Odense V (DK); Benni SIGURGEIRSSON LUND, Aarup (DK)

(73) Assignee: ROEQ ApS, Vissenbjerg (DK)

(21) Appl. No.: 19/041,354

(22) Filed: Jan. 30, 2025

(30) Foreign Application Priority Data
Nov. 30, 2023 (DK) PA 2023 30363

(51) Int. Cl. B62B 5/04

(52) U.S. Cl. CPC B62B 5/0485; B62B 5/0404; B62B 5/0438; B62B 2301/044

(57) ABSTRACT

A cart is provided, for transport by a mobile robot. The cart may include a horizontal loading structure and a caster frame arranged below the loading structure. The caster frame may include two sets of parallel casters, the two sets being spaced apart to accommodate a mobile robot in between them. The cart may also include at least one brake device being mounted to a caster wheel. The brake device may be configured to increase the torque needed for spinning the caster wheel.

This application claims priority under 35 USC 119(a)-(d) from Danish patent application No. PA 2023 30363 filed Nov. 30, 2023, the entire contents of which are incorporated herein by reference

### TECHNICAL FIELD

The present invention relates to a cart for mobile robots, and to a brake device for such cart. The present invention also relates to a throttling mechanism that is attached to carts for mobile robots. In particular, the present invention relates to an arrangement for improving the attach/detach operation of carts to/from a mobile robot.

### BACKGROUND

Mobile robots are used in various applications for providing automatic transport of goods, fixtures, shelves, carts etc. for logistic purposes in production and logistics facilities. Based on the variety of needs and requirements of the particular application, there is a need for improved solutions.

### SUMMARY

An object is to solve a general problem that arises where the implementation of automation is increasing the demand for precision placing the carts correctly at the pick-up and delivery areas, especially at those areas where carts are picked-up and/or delivered by a mobile robot.

In general it is important to make carts running with low friction to increase the maximum payload that can be maneuvered by a mobile robot. Carts with low friction has on the other hand some difficulties standing still when the flooring conditions are not optimal, e.g. when the floor is uneven. When the floor has small grooves or other irregularities, the cart may start to roll after it has been positioned by an operator or by a mobile robot.

In practice this phenomenon is most problematic when the cart is empty or loaded with goods with a low weight. Therefore, according to a general concept a mechanism is provided that holds the cart back with a small and consistent force. Such mechanism would be beneficial for ensuring a high performance for cart systems managed by mobile robots, since the precision at picking up and delivery of carts would then be improved, due to reduced risk of carts rolling away when the mobile robot is not attached to the cart.

Cart systems may have varying wheel configurations depending on e.g. application, payload and need for human intervention. The typical configurations are: i) four wheel carts with four swivel casters; ii) four wheel carts with two fixed casters and two swivel casters; six wheel carts with six swivel casters; and six wheel carts with two fixed casters and four swivel casters.

An idea is to provide a throttling mechanism (i.e. a brake device) that is attached to a cart for mobile robots that is introduced to obtain a more stable cart positioning when the cart is placed in free space. This is to improve the attach/detach operation of cart to/from a mobile robot and a potential operator placing the cart precisely at a pick-up/drop-off location.

According to a first aspect, an arrangement for a cart, is provided. The arrangement comprises minimum one interfacing component interacting with a wheel on the cart creating a force friction to said wheel increasing the torque needed for spinning said wheel.

The arrangement may be able to interact with wheels placed on fixed casters and/or wheels on swivel casters.

The arrangement may be placed at least on two wheels.

The arrangement may have a rolling element making the interface from the arrangement to the wheel, thereby applying an increased torque for spinning the wheel.

The arrangement may have a friction element sliding against the wheel, thereby applying an increased torque for spinning the wheel.

The arrangement may have an element that adds a uniform force from the arrangement towards wheel. The element could be a spring, an added weight or alike.

The arrangement may be configured to be activated/deactivated by having an additional mechanism that detaches or reduces the impact on the wheel to reduce the applied torque needed to spin the wheel.

The mechanism may be configured to get the detachment force applied by utilizing the engagement interface between the top module on the mobile robot and the cart.

The mechanism may be configured to get the detachment force applied by operator input through a mechanism placed on the cart itself.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

The invention will be described in further detail below with reference to the accompanying drawings, in which

FIG. 1 is a perspective view of a cart according to one embodiment.

FIG. 2 is a side view of a cart according to one embodiment.

FIG. 3 is a side view of a cart according to one embodiment.

FIG. 4 is a side view of a cart according to another embodiment.

FIG. 5 is a side view of a cart according to a further embodiment.

FIGS. 6 and 7 are side views of a cart according to one example, configured in two different states or modes.

FIGS. 8 and 9 are side views of a cart according to another example, configured in two different states or modes.

FIG. 10 is a side view of a cart according to a further example.

### DETAILED DESCRIPTION

The detailed description set forth below provides information and examples of the disclosed technology with sufficient detail to enable those skilled in the art to practice the disclosure.

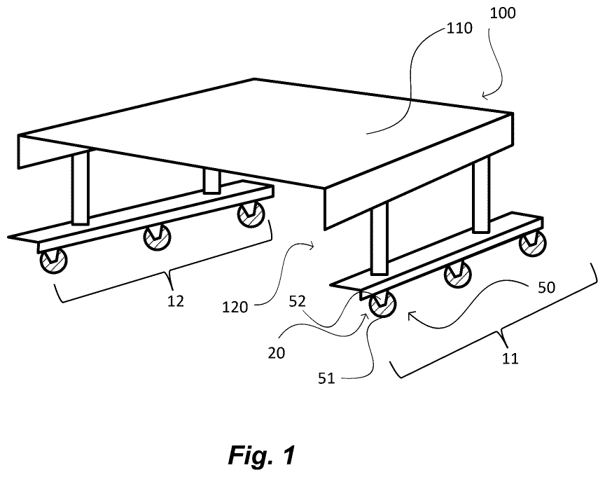

In FIG. 1 a cart 100 for transport by a mobile robot according to one exemplary embodiment is shown. The cart 100 comprises a horizontal loading structure 110 and a caster frame 120 arranged below the loading structure 110. The caster frame 120 comprises a plurality of casters 50. The caster frame 120 comprises two sets 11, 12 of parallel casters 50, the two sets 11,12 being spaced apart to accommodate a mobile robot (not shown) in between them. Each set 11, 12 of parallel casters 50 comprises one or more casters 50. In the exemplary embodiment of FIG. 1 the cart 100 comprises two sets 11, 12 of parallel casters 50 each comprising three casters 50 each. It is easily understood that the number of casters 50 per set 11, 12 of parallel casters 50 may be easily altered to fit a certain environment or use case of the cart 100.

The casters 50 may comprise a caster wheel 51 and a caster bracket 52. The caster wheel 51 may be configured to form a rolling interface between the cart 100 and the ground or floor. The caster bracket 52 may form a rotationally secured connection between the caster frame 120 and the caster wheel 50. The caster bracket 52 may be a fixed caster bracket or a swivel caster bracket. A fixed caster may restrict the movement of the caster wheel 51 to one rotational plane. The caster wheel 51 and the fixed caster bracket may together form a fixed caster. A swivel caster may allow the caster wheel to rotate in a number of different rotational planes, preferably along a vertical rotational axis. The caster wheel 51 and the swivel caster bracket may together form a swivel caster. The sets 11, 12 of parallel casters 50 may comprise a mix of fixed casters and swivel casters.

The cart 100 further comprises at least one brake device 20 configured to act on the caster wheel 51 and increase the torque needed for spinning said caster wheel 51. The caster wheel 51 is understood to be one or more of the plurality of caster wheels 51 of the cart 100. Each brake device 20 may preferably act on one caster wheel 51.

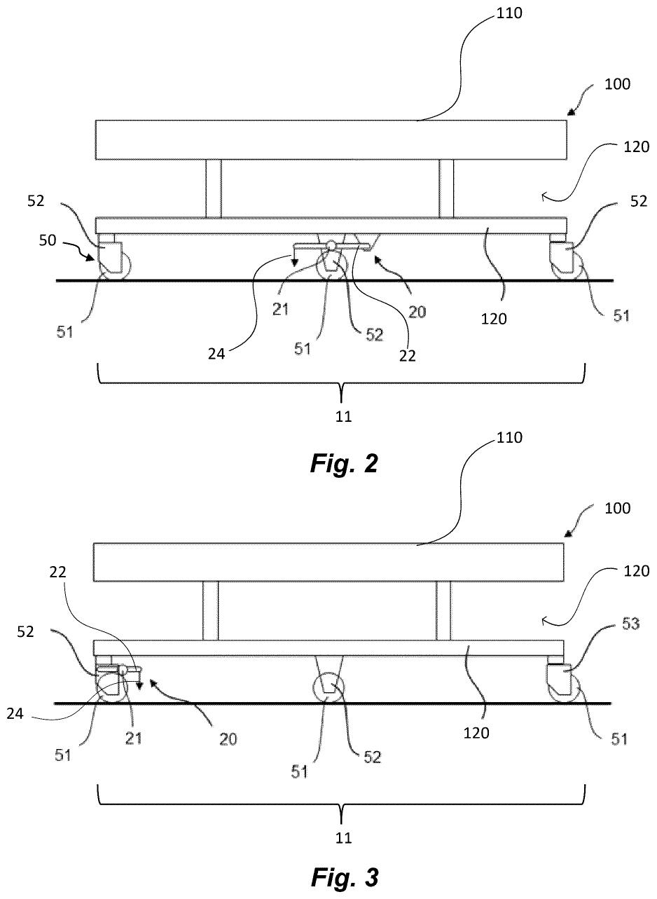

In FIG. 2 a side view of the cart 100 according to an exemplary embodiment is shown. One of the casters 50 is provided with the brake device 20. The brake device 20 may comprise an interfacing component 21 configured to add friction to the caster wheel 51 of said caster 50. The interfacing component 21 may be arranged at the perimeter of said caster wheel 51. The brake device 20 may be configured to act on a caster wheel 51 mounted to a swivel caster or a caster wheel 51 a fixed caster.

In the embodiment of FIG. 2 the interfacing component 21 is a rolling element arranged to roll against the perimeter of the caster wheel 51. The interfacing component 21 may introduce friction to the caster wheel 51 as it rolls against the perimeter of the caster wheel 51 and thereby increase the torque needed to spin said caster wheel 51.

The brake device 20 may be mounted to the caster frame 120. The brake device 20 may comprise a lever arm 22 connected to the caster frame 120 by a pivot connection. The pivot connection may be at a first end of the lever arm 22. The interfacing component 21 may be arranged on the lever arm 22, preferably at an intermediate position between the two ends of the lever arm 22. The lever arm 22 may extend above the caster wheel 51. The lever arm 22 may extend through the caster bracket 52. The lever arm 22 may have a free second end which is opposite the first end of the lever arm 22.

The brake device 20 may further comprise a biasing member 24 configured to add a uniform force to the associated caster wheel 51. The lever arm 22 may have a weight and thereby by itself form the biasing member 24 due to gravity. Gravity acting on the free second end of the lever arm 22 may pivot the lever arm 22 downward toward the perimeter of the caster wheel 51. The weight of the lever arm 22 may press the interfacing component 21 against the perimeter of the caster wheel 51. Preferably, the materials of the interfacing component 21 and the perimeter of the caster wheel 51 may be selected such that the static friction is relatively high, and such that the kinetic friction is relatively low.

The cart 100 may comprise at least two brake devices 20 configured to act on separate casters 50. It may be preferable for the at least two brake devices 20 to be configured to act on at least one caster 50 of each set of parallel casters 11,12.

In FIG. 3 a side view of the cart 100 according to another embodiment is shown. The cart depicted in FIG. 3 is similar to the cart 100 shown in FIG. 2 except for that the brake device 20 is configured to act on another caster 50. In FIG. 3 the brake device 20 is shown to act on the caster 50 arranged at one of the ends of the caster frame 120. The brake arrangement 20 may be connected to the caster bracket 52 of the caster 50, such that the lever arm 22 is pivotally connected to the caster bracket 52.

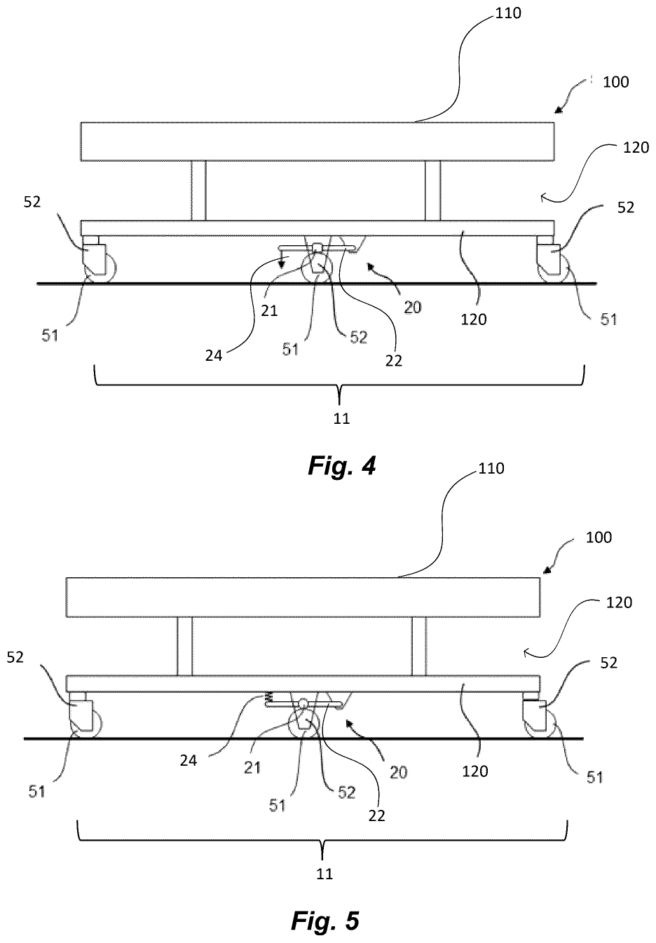

In FIG. 4 a side view of the cart 100 according to an embodiment is shown. The cart depicted in FIG. 4 is similar to the cart 100 shown in FIG. 2 except for that the interfacing component 21 is a sliding element, such as a sliding member or a sliding block/bar arranged to slide against the perimeter of the caster wheel 51. The sliding element 21 may add friction to the caster wheel 51 thereby increasing the torque needed to spin said caster wheel 51.

FIG. 5 is a side view of the cart 100 according to an embodiment. The brake device 20 of the cart 100 in this exemplary embodiment comprises a biasing member 24 formed by a spring. The spring 24 may be a compression spring. The compression spring 24 may provide a force acting on the lever arm 22 in a downward direction such that the interfacing component 21 presses against the perimeter of the caster wheel 51. The spring 24 may be connected to a second end of the lever arm 22 opposite the pivotally supported first end of the lever arm 22. The biasing member 24 may be connected between the caster frame 120 and the lever arm 22 of the brake arrangement 20.

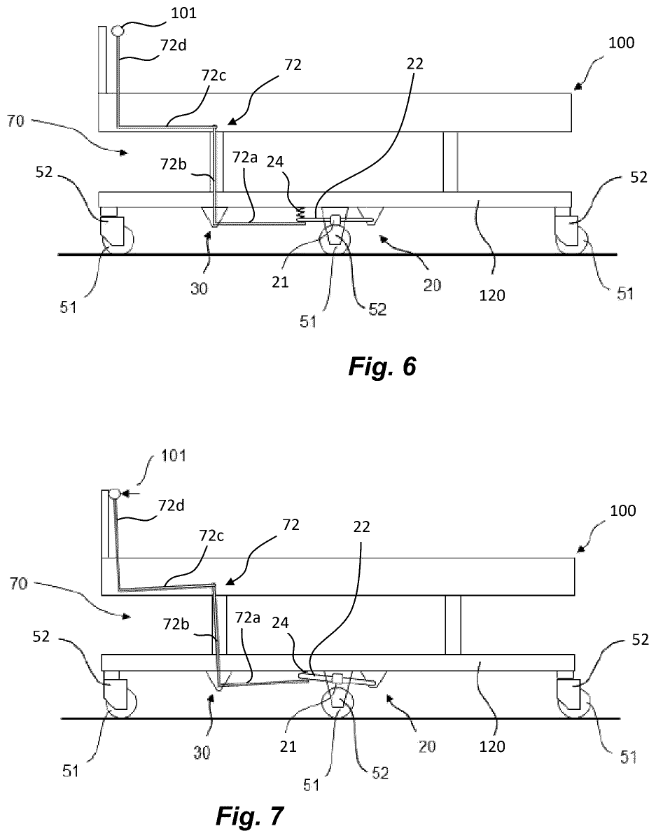

Another example of a cart 100 is shown in FIGS. 6-7. The cart 100 comprises one or more brake devices 20 in order to reduce the risk for unintentional movement of the cart 100, especially when the cart 100 is unloaded or loaded with a small weight only. In the shown example, the brake device 20 comprises an interfacing component 21 in the form of a sliding element, or sliding member arranged adjacent to a perimeter of a caster wheel 51. The brake device 20 further comprises an actuator 70 configured to selectively deactivate the brake device 20. In an idle position, the actuator 70 is in an activated position such that increased friction is applied to the caster wheel 51 due to the interfacing component 21 being in contact with the caster wheel 51.

The interfacing component 21 is arranged between two ends of a lever arm 22. The first end of the lever arm 22 is pivotally secured to a fixed structure, such as the caster bracket 52 or the caster frame 120. The opposite, second end is connected to a fixed structure 52, 120 via a spring 24. The spring 24 urges the lever arm 22 to pivot downwards, thereby pushing the interfacing component 21 against the perimeter of the caster wheel 51. To allow the caster wheel 51 to rotate more freely, the force of the spring 24 needs to be reduced.

The same second end of the lever arm 22, i.e. the end connected to the spring 24, is connected to a link rod 72 forming the actuator 70. The link rod 72 extends away from the interfacing component 21 and upwards, such that it is manually accessible for an operator e.g. by means of a handle 101. In the shown example the link rod 72 comprises a plurality of connected segments 72a-d such that the link rod 72 extends from the lever arm 22 to the handle 101 arranged at the upper side of the cart 100. The link rod 72 comprises at least a lever arm segment 72a directly connected to the lever arm 22; and a manoeuvre segment 72d directly or indirectly connected to the lever arm segment 72a. The manoeuvre segment 72d is accessible for the operator and may for this purpose be provided with the handle 101.

The link rod 72 is connected to the caster frame 120 via a pivot joint 30. In the shown example, the lever arm segment 72a is at one end connected to the lever arm 22, and the opposite end is pivotally supported by the caster frame 120 at the pivot joint 30. Hence, when the link rod 72 is operated, the lever arm segment 72a will be allowed to pivot.

In the shown example, when the manoeuvre segment 72d is pushed in the direction of the arrow, the lever arm segment 72a will be forced to pivot thereby pushing the end connected to the lever arm 22 upwards. This will release at least some of the biasing force of the spring 24, thereby allowing the cart 100 to move more freely.

Preferably the actuator 70 is configured to be locked in any of its end positions, using any suitable locking mechanism.

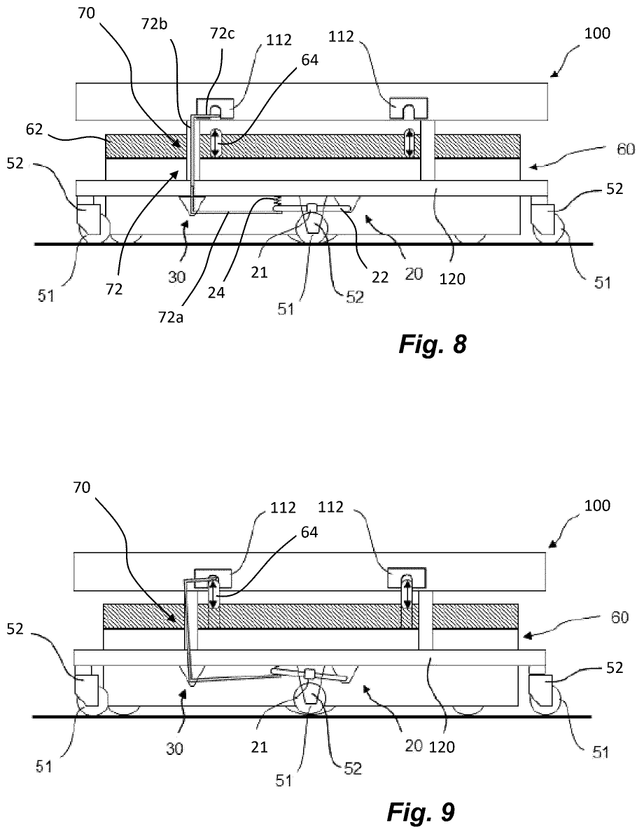

Another example of a cart 100 is shown in FIGS. 8-9. The cart 100 comprises one or more brake devices 20 in order to reduce the risk for unintentional movement of the cart 100, especially when the cart 100 is unloaded or loaded with a small weight only. In the shown example, the brake device 20 comprises an interfacing component 21 in the form of a sliding element, or sliding member arranged adjacent to a perimeter of a caster wheel 51. The brake device 20 further comprises an actuator 70 configured to selectively deactivate the brake device 20. In an idle position, the actuator 70 is in an activated position such that increased friction is applied to the caster wheel 51 due to the interfacing component 21 being in contact with the caster wheel 51. This state is shown in FIG. 8.

A mobile robot 60 has moved to the cart 100 such that the mobile robot 60 is positioned in between the two sets of casters 50. The mobile robot 60 is provided with a top module 62 forming an interface with surrounding equipment, in this case the cart 100. It should be noted that the top module 62 may also be configured to interact with other components of a logistics environment, such as fixed conveyors, docketing stations, items to be moved, etc. The top module 62 comprises connectors 64 for connecting the mobile robot 60 to the cart 100. The connectors 64 are here in the form of vertically projecting pins. Typically, the pins 64 are controllable between a withdrawn position, seen in FIG. 8, to a projected position as shown in FIG. 9. The control of the pins 64 may be performed automatically by detecting that the mobile robot 60 is positioned correctly relative a cart 100, or projection of the pins 64 may be controlled manually by operator input.

Similar to the embodiment shown in FIGS. 6-7, the interfacing component 21 is arranged between two ends of a lever arm 22. One end of the lever arm 22 is pivotally secured to a fixed structure, such as the caster bracket 52 or the caster frame 120. The opposite end is connected to a fixed structure 52, 120 via a spring 24. The spring 24 urges the lever arm 22 to pivot downwards, thereby pushing the interfacing component 21 against the perimeter of the caster wheel 51. To allow the caster wheel 51 to rotate more freely, the force of the spring 24 needs to be reduced.

The same end of the lever arm 22, i.e. the end connected to the spring 24, is connected to a link rod 72 forming the actuator 70. The link rod 72 extends away from the interfacing component 21 and upwards; the end of the link rod 72 is positioned in cooperation with a pin receiving recess 112 on the underside of the loading structure 110 of the cart 100. When the mobile robot 60 is positioned for locking to the cart 100, the pin receiving recess 112 is aligned with the pin 64.

In the shown example the link rod 72 comprises a plurality of connected segments 72a, 72b, 72c such that the link rod 72 extends from the lever arm 22 to the pin receiving recess 112. The link rod 72 comprises at least a lever arm segment 72a directly connected to the lever arm 22; and a manoeuvre segment 72c directly or indirectly connected to the lever arm segment 72a. In the shown example, the lever arm segment 72a is extending to the manoeuvre segment 72c via an intermediate segment 72b. The manoeuvre segment 72c is configured to be manoeuvred by the pin 64 of the top module 62.

The link rod 72 is connected to the caster frame 120 via a pivot joint 30. In the shown example, the lever arm segment 72a is at one end connected to the lever arm 22, and the opposite end is pivotally supported by the caster frame 120 at the pivot joint 30. Hence, when the link rod 72 is operated, the lever arm segment 72a will be allowed to pivot.

In the shown example, when the manoeuvre segment 72c is pushed upwards by the pin 64 protruding to engage with the pin receiving recess 112, the lever arm segment 72a will be forced to pivot thereby pushing the end connected to the lever arm 22 upwards. This will release at least some of the biasing force of the spring 24, thereby allowing the cart 100 to move more freely.

Hence, the cart 100 is subjected to increased friction when it is resting without any connection with a mobile robot 60. As soon as the mobile robot 60 connects to the cart 100, the brake device 20 will be released whereby the friction is reduced, thereby allowing for a less restricted movement of the cart 100.

In an optional example, the manoeuvre segment 72c ends at the upper side of the loading structure 110 of the cart 100. The manoeuvre segment 72c may have a spring biased terminal end, which spring is caused to compress when a load is placed onto the loading structure 110. Hence, by selecting a specific spring the release of the brake device 20 may be continuous based on the weight of the load; a heavy load will release the brake device 20 completely, while a lesser load will cause a partial release of the brake device 20.

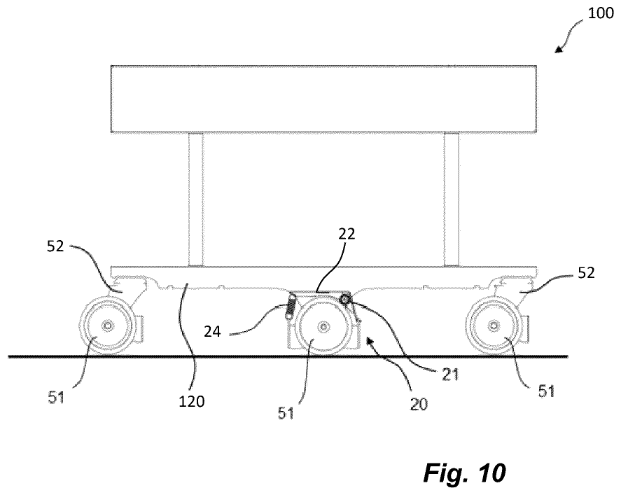

In FIG. 10 another example of a brake device 20 is shown. The brake device 20 is similar to the example described with reference to FIG. 5. The brake device 20 comprises a biasing member 24 formed by a spring. The lever arm 22 is in this example at least partly accommodated inside the caster 50 and has at least a portion following the contour of the perimeter of the caster wheel 51. The biasing member 24 may be a compression spring. The compression spring 24 may provide a force acting on the lever arm 22 in a downward direction such that the interfacing component 21, here in the form of a rolling element, presses against the perimeter of the caster wheel 51. The spring 24 may be connected to one end of the lever arm 22 opposite a pivotally supported end of the lever arm 22. The biasing member 24 may be connected between the caster frame 120 or the caster bracket 52 and the lever arm 22 of the brake arrangement 20.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

### LIST OF EXAMPLES

Example 1. An arrangement (20) for a cart (50), comprising minimum one interfacing component (21, 22) interacting with a wheel (51) on the cart (50) creating a force friction to said wheel (51) increasing the torque needed for spinning said wheel (51).
Example 2. The arrangement according to Example 1, are able to interact with wheels (51) placed on fixed casters (52) and/or wheels (51) on swivel casters (53).
Example 3. The arrangement according to Example 1, are placed at least on two wheels (51).
Example 4. The arrangement according to Example 1, characterized by having a rolling element (21) making the interface from the arrangement (20) to the wheel (51), thereby applying an increased torque for spinning the wheel.
Example 5. The arrangement according to Example 1, characterized by having a friction element (22) sliding against the wheel (51), thereby applying an increased torque for spinning the wheel.
Example 6. The arrangement according to Example 4 and 5, characterized by having an element (53) that adds a uniform force from the arrangement (20) towards wheel (51). The element (53) could be a spring, an added weight or alike.
Example 7. The arrangement according to Example 4 and 5, characterized by being activated/deactivated by having an additional mechanism (30) that detaches or reduces the impact on the wheel (51) to reduce the applied torque needed to spin the wheel (51).
Example 8. The mechanism according to Example 7, characterized by getting the detachment force applied by utilizing the engagement interface (52) between the top module (70) on the mobile robot (60) and the cart (50).
Example 9. The mechanism according to Example 7, characterized by getting the detachment force applied by operator input (101) through a mechanism (30) placed on the cart (50) itself.

What is claimed:

1. A cart for transport by a mobile robot, the cart comprising:
a horizontal loading structure; and
a caster frame arranged below the loading structure;
wherein the caster frame has two sets of parallel casters, the two sets being spaced apart to accommodate a mobile robot in between them; and
at least one brake device configured to act on a caster wheel to increase the torque needed for spinning the caster wheel.

2. The cart of claim 1, wherein the brake device comprises an interfacing component configured to add friction to the caster wheel.

3. The cart of claim 2, wherein the interfacing component is arranged at the perimeter of the caster wheel.

4. The cart of claim 1, wherein the brake device is configured to act on a caster wheel of a swivel caster or a fixed caster.

5. The cart of claim 1, further comprising at least two brake devices configured to act on separate caster wheels.

6. The cart of claim 2, wherein the interfacing component is a rolling element arranged to roll against the perimeter of the caster wheel.

7. The cart of claim 2, wherein the interfacing component is a sliding element arranged to slide against the perimeter of the caster wheel.

8. The cart of claim 1, wherein the brake device further comprises a biasing member configured to add a uniform force to the caster wheel.

9. The cart of claim 8, wherein the biasing member is a spring or a weight.

10. The cart of claim 1, wherein the brake device further comprises an actuator configured to selectively activate or deactivate the brake device.

11. The cart of claim 10, wherein the brake device is configured to have an idle state in which it is activated to increase the torque required to spin the caster wheel; and
wherein the actuator is configured to selectively deactivate the brake device to reduce the torque needed to spin the caster wheel.

12. The cart of claim 10, wherein the actuator is configured to be engaged by an actuator interface of an associated mobile robot.

13. The cart of claim 12, wherein the actuator is configured to automatically deactivate the brake device when the associated mobile robot is connected to the cart.

14. The cart of claim 10, wherein the actuator is configured to be manually manoeuvrable to deactivate or activate the brake device.

15. The cart of claim 10, wherein the actuator is configured to deactivate the brake device when a load is positioned onto the loading structure of the cart.

16. A brake device for a cart being configured to be transported by a mobile robot, wherein the brake device is configured to be mounted to a caster wheel of the cart and being configured to increase the torque needed for spinning the caster wheel.

17. The brake device according to claim 16, wherein the brake device comprises an actuator configured to selectively deactivate the brake device.

18. The brake device according to claim 16, further comprising a rolling element configured to roll against a perimeter of the caster wheel.

19. The brake device according to claim 16, further comprising a sliding element configured to slide against a perimeter of the caster wheel.

20. A system comprising:
a mobile robot; and
a cart configured to be transported by the mobile robot;
wherein the cart comprises a brake device being mounted to a caster wheel of the cart, the brake device being configured to selectively increase the torque needed for spinning the caster wheel.
